(19) United States
(12) Patent Application Publication
(10) Pub. No.: US 2019/0078247 A1
(43) Pub. Date: Mar. 14, 2019

(54) DEVICE AND METHOD FOR CONTINUOUS COATING OF CARBON FIBRES WITH AN ELECTROCHEMICAL METHOD

(71) Applicant: ISTANBUL TEKNIK UNIVERSITESI REKTORLUGU, Istanbul (TR)

(72) Inventors: A. Sezai SARAC, Istanbul (TR); Burcu SAYINLI, Istanbul (TR)

(73) Assignee: ISTANBUL TEKNIK UNIVERSITESI REKTORLUGU, Istanbul (TR)

(21) Appl. No.: 16/075,152

(22) PCT Filed: Jan. 18, 2017
(86) PCT No.: PCT/TR2017/050028

§ 371 Date: Aug. 3, 2018

(30) Foreign Application Priority Data
Feb. 12, 2016 (TR) 2016/01856

(51) Int. Cl. D06B 3/02; D01F 11/16; D06M 15/356; D06M 23/00; H01B 1/04; H01B 1/24

(52) U.S. Cl. CPC D06B 3/02; D01F 11/16; D06M 15/3562; D06M 2101/40; D06M 23/00; H01B 1/04; H01B 1/24; D06M 15/3566

(57) ABSTRACT

The invention is related to a continuous system for coating carbon fibre materials and a device developed to carry out the method. The coating of carbon fibre with both an electrochemical method following the polymerization (polyethylenedioxythiophene, polypyrrole, polythiophene, polyaniline and derivates thereof) of the monomer of conductive polymer and coating with an insulating sizing material (thickening material) is carried out in a single step.

### CROSS REFERENCE TO RELATED APPLICATIONS

This application is the national phase entry of International Application PCT/TR2017/050028, filed on Jan. 18, 2017, which is based upon and claims priority to Turkish Patent Application No. 2016/01856, filed on Feb. 12, 2016, the entire contents of which are incorporated herein by reference.

### TECHNICAL FIELD

The invention is related to a continuous system for coating carbon fibre materials and a device developed carry out said method. The coating of carbon fibre with both an electrochemical method following the polymerization (polyethylenedioxythiophene, polypyrrole, polythiophene, polyaniline and derivates thereof) of the monomer of the conductive polymer and coating with an insulating sizing (thickening) material is carried out in a single step.

### BACKGROUND

The coating of carbon fibre materials is carried out in several different techniques. Some of these techniques are coating methods such as are coating with smearing, one sided coating, stripping molten polymer off a surface. Some of the device systems utilizing these coating methods have been designed to carry out continuous, or intermittent coating.

The applications in the prior art is related to continuous coating of carbon fibre with insulation materials however the electrochemical coating of carbon fibre in a continuous system has not been described. This leads to poor binding between the intermediate surface located between the polymer matrix and the strengthening carbon fibre. Prior applications also do not perform coating of carbon fibre in a continuous system in the same environment as electrochemical methods and in the presence of a sizing material and therefore this has led to the need for a development in this field.

The studies that have been provided comprise the coating of carbon fibre with impregnation with plastic and isolative matrix elements such as resins. The mechanical features of carbon fibre are tried to be further improved by means of said coating methods.

The coating procedure of carbon fibre in the known state of the art is carried out in a continuous flow system. Following such coating procedures, a new coating can be carried out in a coating bath, using an electrochemical (electrolysis) method, however even said procedure shall be a two steps procedure. Therefore, if both coats need to be coated, this shall bring about disadvantages such as longer coating times, increase in coating costs, and increase in usage of chemicals. Generally electrochemical metal coating procedures need to be carried out in a small scale and intermittent (non-continuous) system.

When inventions similar to said invention have been examined, the following documents have been encountered:
In the patent document numbered U.S. Pat. No. 2,699,415A, the production of durable fibres coated with a continuous process is described. The fibres are passed through a melting tank comprising refractor material, and following this, the fibres are coated with a coating material comprising an inorganic material using a chemical method and these fibres are then brought together.
The patent document numbered CN104195838A, describes the coating of carbon fibre surfaces, with polyethyleneimine using a chemical method in a non-continuous system.
The patent document numbered EP1892319A1 places into protection a method and a device which carries out coating of both surfaces of a material, with a continuous system, simultaneously. Immersion-coating is carried out using a wet chemical process (such as MOD). The immersion-coating unit; comprises a coating bath, an oven, feeding means, drawing means and a pre-drying section.

### SUMMARY

According to this designed system, the process which can be carried out in at least two steps is aimed to be carried out in a single unit (batch). The carrying out coating in a smaller scale with a continuous system rather than a large scale, two stepped systems, shall help to reduce both financial expenses and shall increase higher yield in terms of easier adaptation of the system to each other and to production.

By means of this system, subject to said invention, both electrochemical coating and non-electrochemical binding can be performed at the same time in a continuous system. During this process, chemical materials are coated onto carbon fibre and a coating thickness is created. This coating thickness that has been obtained, is changed by adjusting the experimental parameters in a controlled manner and the desired coating thickness can be obtained. The changing of parameters also leads to changing of mechanical, physical and electrical aspects of modified carbon fibre. As a result, the system allows continuous modified carbon fibre production having the desired features and thicknesses.

We can define the coating and therefore the parameters which affect the features of modified carbon fibre as follows; the rotation speed of the power supply which aids in rotating the motor which enables fibre bundle flow, hence the advancing speed of a fibre bundle, coating time, coating solvent concentration, and types of electrodes and chemicals used. By adjusting said parameters, following the coating process, the desired optimum coating thickness of the material and the material characteristics (porosity, conductivity etc) in a continuous system is reached.

### BRIEF DESCRIPTION OF THE DRAWINGS

FIG. 1: Device and its related parts designed to perform carbon fibre coating.

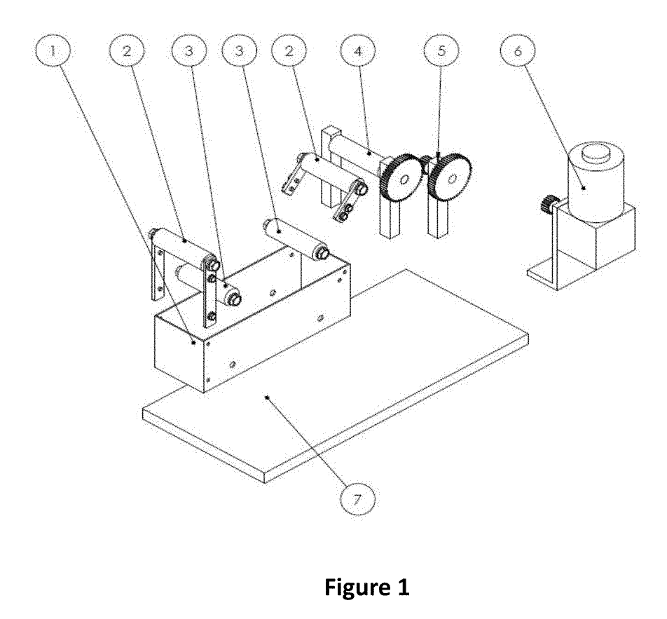

FIG. 2: Device designed to perform carbon fibre coating.

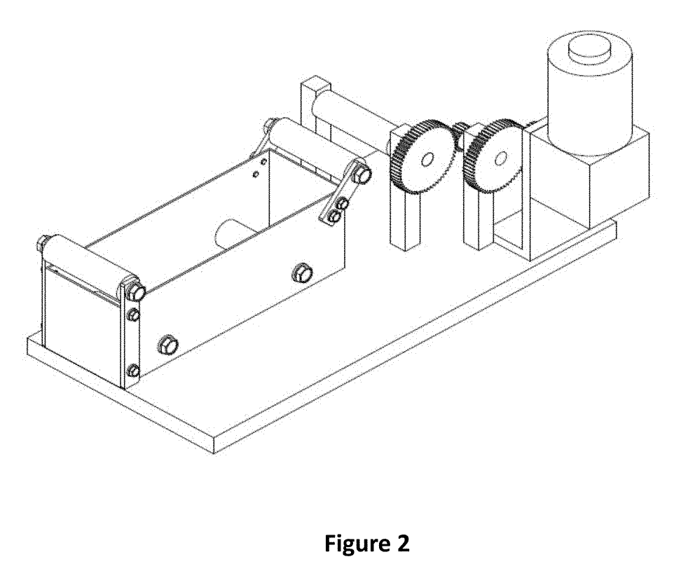

FIG. 3: The side, rear and top view of the device designed to perform carbon fibre coating.

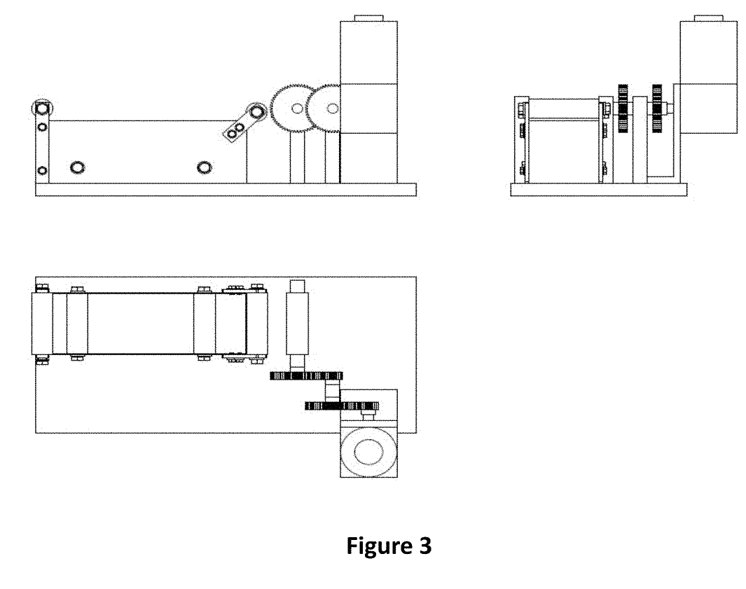

FIG. 4: Device designed to perform carbon fibre coating and system in which said coating method is applied.

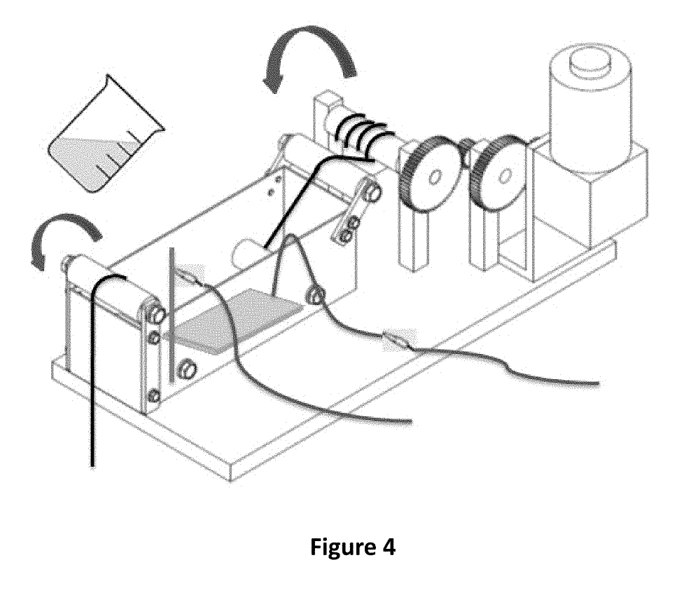

FIG. 5: Images taken with a scanned electron microscope (SEM at 1μ and 4μ) scale of carbon fibres coated with polypyrrole and polyethylenedioxythiophene respectively.

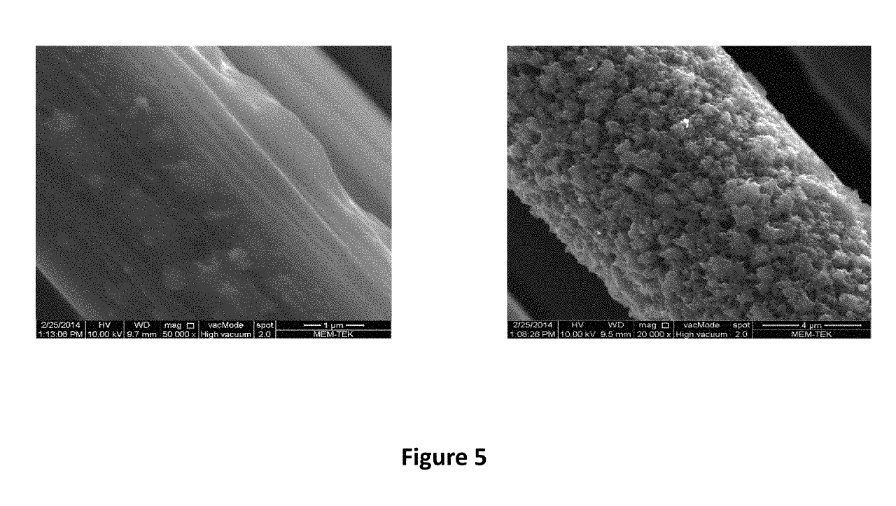

### PARTS RELATED TO THE INVENTION

8. Coating bath
9. External guide cylinder
10. Internal guide cylinder
11. Brass metal rotating cylinder
12. Gears
13. Motor
14. Platform.

### DETAILED DESCRIPTION

Carbon fibre is a material having high mechanical, physical and electrical features that are used in several sectors such as automobiles, aviation, space/aeronautics, electronic, construction and building of wind turbines etc.

The system that has been designed to carry out a carbon fibre coating procedure, is in pilot scale and it can also be adapted to a large scale, and it is a design suitable to perform speed control, enable continuous fibre flow, and to simultaneously perform coating with electrochemical conductive polymers and a sizing (thickening) material. A platform (7) is provided which is made of rigid material in order to support the base of the system. A coating tank (1) which is fixed to the platform and in which a process is carried out has also been provided. A total number of four cylinders have been installed into the coating tank such that two of said cylinders are located inside (3) the tank and the other two are located outside (2) the tank. These internal and external guide cylinders (2,3) are coated with Teflon material and therefore it has been prevented from said units and said co process to be adversely effected during said coating process.

A fifth brass metal rotating cylinder (4) different from said four cylinders is also provided outside of the coating tank and it is connected to the electric motor (6) having a certain speed controlled by means of the gears (5). The carbon fibre material that is to be coated is wound around a brass metal rotating cylinder which is located outside of the coating tank. This winding procedure, is carried out by the aid of a power supply and the motion of the cylinder that is connected to the motor.

The electric motor having a certain speed applies the desired amount of force to the system. The motor of the coating system, converts the electric energy into kinetic energy and enables the gears to rotate at the desired speed. A potentiostat (power supply) is used to support the system for an electrochemical coating process to be performed.

The electrodes (silver wire can be preferred as a reference electrode and a steel plate can be preferred as a counter electrode) that are connected to the power supply are placed inside the coating tank and are fixed therein. The chemicals that are desired to be coated with a carbon fibre material (resins, electroactives, related monomers that shall provide conductive polymers) are brought together inside a suitable solvent medium and following this the coating is transferred into the coating tank. The carbon fibre material to be coated is passed over the rotating cylinders and is delivered to the coating tank (1) at a certain speed The coating process is carried out by means of the electric potential effect applied both to the coating solvent and the motion of the system during the time when the carbon fibre bundle which acts as a working electrode, comes into contact with the coating solution inside the coating tank. The carbon fibre material that has been taken out of the coating tank by means of the motion of the cylinders, is discharged from the system such that it has been coated with a conductive polymer (polyethylenedioxythiophene, polypyrrole, polythiophene, polyaniline and derivates thereof), and a sizing (thickening) material by means of an electrochemical method. As a result, without any intervals, the carbon fibre material is coated with two components (conductive polymer and sizing agent) homogenously in a controlled manner within a continuous system.

According to this system which has been designed, the conditions and amounts of the two different monomer and sizing (thickening) agents to be used in order to coat the carbon fibre bundle have been given as examples below for illustration purposes;
Polyethylenedioxythiophene and carbon fibre coated with a thickening material: An electrolyte solution is prepared by dissolving 0.1M sodium perchlorate salt inside acetonitrile. A new coating mixture comprising 0.5% sizing (thickening) agents by volume and 2 mM ethylenedioxythiophene as monomer of conductive polymer solution is prepared using said solution. The mixture that has been prepared is poured into the coating tank and 1.5V potential is applied to the system by means of electrodes from a potentiostat device. The carbon fibre bundle shall be coated at the same time, in a continuous system with a conductive polymer (polyethylenedioxythiophene) and a sizing (thickening) agent.
Polypyrrole and carbon fibre coated with a sizing (thickening) material:

An electrolyte solution is prepared which is dissolved inside a solvent mixture comprising 0.1M sodium perchlorate salt, 20% acetonitrile and 80% water. A new coating mixture comprising 0.35% sizing (thickening) agents by volume and 6.25 mM Pyrrole conductive monomer solution is prepared using said solution. The mixture that has been prepared is poured into the coating tank and 1.0V potential is applied to the system by means of electrodes from a potentiostat device. The carbon fibre bundle shall be coated at the same time, in a continuous system with a conductive polymer (polypyrrole) and a sizing (thickening) agent.

What is claimed is:

1-6. (canceled)

7. A carbon fibre coating method comprising:—
placing and fixing a steel electrode and a platinum electrode coupled to a power supply into a coating tank;
mixing a chemical to be coated to a carbon fibre material inside a solvent medium to prepare a coating solution;
pouring the coating solution into the coating tank;
passing the carbon fibre material to be coated over a polytetrafluoroethylene rotating cylinder and delivering the carbon fibre material to be coated to the coating tank at a predetermined speed; wherein
the coating process is carried out by means of an electric potential effect applied to both of the coating solution and a motion of a system during the time when a carbon fibre bundle comes into contact with the coating solution inside the coating tank;
the carbon fibre material, being taken out of the coating tank by means of a motion of the rotating cylinder, is discharged from the system, such that the carbon fibre material is coated with a conductive polymer and a sizing agent material by means of an electrochemical method.

8. The carbon fibre coating method according to claim 7, wherein a potentiostat is used to support the system for the electrochemical method to be performed.

9. The carbon fibre coating method according to claim 7, wherein the chemical is selected from the group consisting of resins, electroactive materials, and conductive monomers.

10. A device for carbon fibre coating, comprising:
a platform made of a rigid material in order to support a base of a system;
a coating tank fixed to the platform, wherein a coating process is carried out in the coating tank;
two external guide cylinders, wherein the two external guide cylinders are configured to carry out a first rotation motion and are located outside the coating tank;
two internal guide cylinders, wherein the two internal guide cylinders are configured to carry out a second rotation motion and are located inside the coating tank;
a brass metal rotating cylinder, wherein the brass metal rotating cylinder is configured to carry out a third rotation motion and are located outside a coating bath;
a plurality of gears, wherein the plurality of gears are configured to carry out a fourth rotation motion by means of electric energy produced by an electric motor and are enabled to convey a carbon fibre wounded around the brass metal rotating cylinder to the system; and
a motor, wherein the motor delivers the electric energy required for driving the system having a predetermined speed, to the system.

11. The device for carbon fibre coating according to claim 10, wherein the internal and external guide cylinders are made of Teflon material.

12. The device for carbon fibre coating according to claim 10, wherein the device is in a pilot scale or a large scale, and the device is configured to perform speed control, enable continuous fibre flow, and to simultaneously perform coating with electrochemical conductive polymers and a sizing agent material.
